(19) United States
(12) Patent Application Publication
(10) Pub. No.: US 2005/0223054 A1
(43) Pub. Date: Oct. 6, 2005

(54) Multiplier sign extension method and architecture

(76) Inventor: Yu-Cheng Lo, Taipei (TW)

Correspondence Address: BIRCH STEWART KOLASCH & BIRCH, PO BOX 747, FALLS CHURCH, VA, 22040-0747, US

(21) Appl. No.: 10/893,226

(22) Filed: Jul. 19, 2004

(30) Foreign Application Priority Data
Apr. 2, 2004 (TW) 93109306

(51) Int. Cl. G06F 7/52

(52) U.S. Cl. 708/625

(57) ABSTRACT

A multiplier sign extension method and architecture are used for encoding operations of a multiplier of a digital signal processor. The multiplier sign extension method comprises the steps of: determining the width of the multiplier to obtain a sign extension bit total value; encoding a multiplier by means of the modified Booth algorithm; calculating out a plurality of layers of partial product terms by multiplying a multiplicand by the encoded multiplier to form a first stepwise bit table; setting a plurality of complementary bits, a first correction bit and a second correction bit to form a second stepwise bit table; and summing up the plurality of layers of the second stepwise bit table. Without increasing critical paths, a plurality of complementary bits is provided for encoding of sign extension to reduce waste of chip area and make the multiplier smaller.

### BACKGROUND OF THE INVENTION

1. Field of the Invention

The present invention relates to a multiplier sign extension method and architecture, whereby a plurality of complementary bits is provided for encoding a multiplier to reduce waste of chip area and make the multiplier smaller.

2. Description of the Related Art

Multipliers are one kind of basic operation component used for almost complex operations. They are also required for the most representative operation—multiplier accumulator (MAC) in digital signal processors (DSP). Multipliers are widely used for digital signal processing like digital filtering. Additionally, a plurality of MACs is accommodated in most existent microprocessors so that they can complete the operations of multiplication and addition within an instruction period.

Generally speaking, a modified Booth algorithm is used for design of a multiplier. This algorithm is an encoding technique capable of reducing half (N/2) of the number (N) of the original partial product terms. Next, a Wallace tree is used to add up these partial product terms. Weights of these partial product terms, however, are different so that a step form will be generated in the Wallace tree. For signed binary multiplication, sign extension to the leftmost of the Wallace tree must be performed on each partial product term.

As shown in FIGS. 1A to 1D, the binary multiplicand is 00101011, and the multiplier is 10011010. The Booth operation has the following basic rules. First, a “0” is added at the rightmost of the multiplicand. Two bits are processed each time. Right shift by one bit is performed after encoding. The rules are: 00 means 0, 01 means +1, 10 means −1, and 11 means 0. Therefore, the 3-bit modified Booth operation has the rules shown in FIG. 1A. First, a “0” is added at the rightmost of the multiplicand. Three bits are analyzed at a time. Right shift by two bits is performed after encoding. The rules are: 000 means 0, 001 means +1, 010 means +1, 100 means −2, 011 means +2, 110 means −1, 101 means −1 and 111 means 0. This is illustrated below. Bit 1 and Bit 2 of “001” are 00, which means 0. Bit 2 and Bit 3 of “001” are 01, which means +1, and 0+1=+1. Bit 1 and Bit 2 of “011” are 01, which means +1, with a weight of 2. Bit 2 and Bit 3 of “001” are 11, which means 0, and 2×(+1)+0=+2. Other results shown in FIG. 1A can be obtained in a similar way.

As shown in FIG. 1B, the multiplier 10011010 is taken apart with 3 bits as the unit of group. Bit 1 and Bit 3 of each group are Bit 3 or Bit 1 of an adjacent group. The first group is P1, the second group is P2, the third group is P3 and the fourth group is P4. If there is one group having less than three bits after the multiplier is taken apart, “0” or “1” must be filled in without affecting the result. In this case, “0” is filled in Bit 3 of the first group P1. From the table shown in FIG. 1A, P1 means −2, P2 means −1, P3 means +2 and P4 means −2.

Performing an operation on the values of the four groups shown in FIG. 1B (i.e., multiplication with the multiplicand) obtains partial product terms −M, −2M, +2M and +M, as shown in FIG. 1C. The length of each group is longer than that of the multiplicand by 1 bit to be able to represent twice the multiplicand without overflow. The excess bit is obtained by means of sign extension. −M means 2's complement of the multiplicand 00101011, i.e., 111001011. −2M means left shifting 2's complement of the multiplicand by 1 bit and then filling a “0” in the last bit, i.e., 110101010. +2M means left shifting the multiplicand by one bit and then filling a “0” in the last bit, i.e., 001010110. +M means filling a “0” at the left side of Bit 1 of the multiplicand, i.e., 000101011. In another formulation, filling a “0” at the left side of Bit 1 of the multiplicand obtains +M, i.e., 000101011. −M means 2's complement of the multiplicand M. −2M means left shifting −M by one bit and then filling a “0” in the last bit. +2M means left shifting the multiplicand M by one bit and then filling a “0” in the last bit.

In the next step, the above partial product terms −M, −2M, +2M and +M are combined with the groups P1, P2, P3 and P4 obtained by encoding the multiplier to obtain the sign extension bit table shown in FIG. 1D. The first row P1′ shows the partial product term of P1 with the value of −2 in FIG. 1B, i.e., the value of −2M: 110101010. The second row P2′ shows the partial product term of P2 with the value of −1 left shifted by two bits. The third row P3′ shows the partial product term of P3 with the value of +2 left shifted by four bits. The fourth row P2′ shows the partial product term of P4 with the value of −2 left shifted by six bits. Partial product terms a, b, c and d in the rows P1′, P2′ P3′ and P4′ form a stepwise bit table shown in FIG. 1D. The stepwise bit table, composed of the partial product terms a, b, c and d of −2M, −M, +2M and −2M, has empty blanks at the left and right sides. Without affecting the result, “0”s are filled in the right blanks, while “0”s or “1”s are filled in the left blanks with reference to Bit 1 of each row. The sign extension bit table shown in FIG. 1D is thus formed. Bit 1 (i.e., the most significant bit (MSB)) of the partial product term a of the first row P1′ is 1, and the left blanks are filled in with “1” (one-extension). Bit 1 of the partial product term b of the second row P2′ is 1, and the left blanks are filled in with “1”. Bit 1 of the partial product term c of the third row P2′ is 1, and the left blanks are filled in with “0”. Bit 1 of the partial product term d of the fourth row P4′ is 1, and the left blanks are filled in with “1”.

Finally, the sign extension bits shown in FIG. 1D are summed up to obtain the product of the multiplicand 00101011 and the multiplier 10011010.

In the step of producing partial product terms of the above modified Booth algorithm, it is necessary to recognize sign extension bits and complement bits. Waste of sign extension will increase with the width of a multiplier.

U.S. Pat. No. 5,251,167 doesn't directly carry out sign extension and then use a compressor to sum up all partial product terms in multiplication operations. Instead, a correction encoder is designed to produce a correction row placed at the lowermost layer of the Wallace tree before summing up all partial product terms finally. This method can exactly reduce waste of chip area in practical use. A layer of correction row, however, is added to increase critical paths, hence affecting the performance.

Zero-extension or one-extension may be performed to sign extension bits generated by partial product terms in the above modified Booth algorithm, hence wasting some judgment and operation time. In order to improve the performance and reduce waste of chip area in the prior art, a plurality of complementary bits is provided for encoding of sign extension without increasing critical paths in the present invention to reduce waste of chip area and make a multiplier be smaller.

### SUMMARY OF THE INVENTION

One object of the present invention is to provide a multiplier sign extension method and architecture for encoding operations used by a multiplier of a DSP, in which a plurality of complementary bits is provided for encoding of sign extension without increasing critical paths to reduce waste of chip area and make the multiplier smaller.

To achieve the above object, the method comprises the steps of: determining the width of the multiplier to obtain a sign extension bit total value; encoding a multiplier by means of the modified Booth algorithm; calculating out a plurality of layers of partial product terms by multiplying a multiplicand by the encoded multiplier to form a first stepwise bit table; setting a plurality of complementary bits, a first correction bit and a second correction bit to form a second stepwise bit table; and summing up the plurality of layers of the second stepwise bit table. The sign extension bit total value can thus be embedded in the plurality of layers of partial product terms without increasing critical paths.

### BRIEF DESCRIPTION OF THE DRAWINGS

The various objects and advantages of the present invention will be more readily understood from the following detailed description when read in conjunction with the appended drawings, in which:

FIGS. 1A to 1D show encoding steps of the 3-bit modified Booth algorithm in the prior art;

FIG. 2A is a diagram of sign extension bits of the present invention;

FIG. 2B is a diagram showing how sign extension bit regions are summing up in the present invention;

FIG. 2C is a diagram of complementary bits of the present invention;

FIG. 3 is a diagram of complementary bits of a second stepwise bit table of the present invention;

FIG. 4 is a flowchart of a multiplier sign extension method of the present invention; and

FIGS. 5A to 5D are steps of a multiplier sign extension method according to an embodiment of the present invention.

### DETAILED DESCRIPTION OF PREFERRED EMBODIMENTS

The present invention provides a multiplier sign extension method and architecture for operations of a multiplier in a digital signal processor (DSP) so that the area of signal extension bits of a DSP chip does not increase and the performance can be maintained. Moreover, the stepwise bit table of the Wallace tree is decreased to reduce critical paths therein.

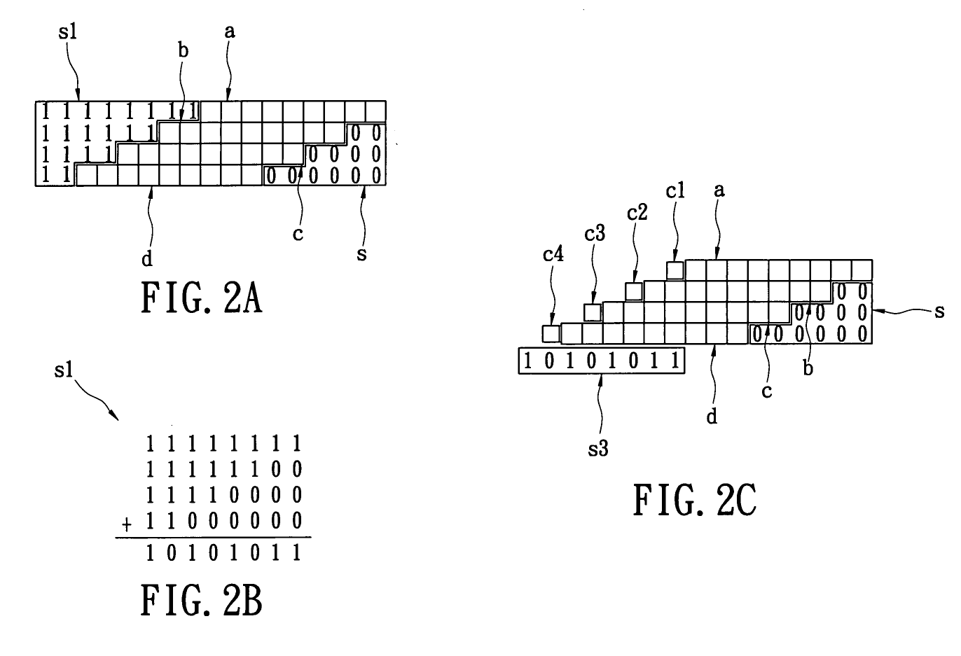

The present invention sets sign extension bits generated by partial product terms in the modified Booth algorithm to 1 (one-extension). In the algorithm, these constant values can first be summed up, and whether there is any complement required is then determined. As shown in FIG. 2A, there are four partial product terms a, b, c and d. In the modified Booth algorithm, a first stepwise bit table is formed. The right sides of this stepwise bit table are filled in with “0”s to form a zero-fill region s0 without affecting the result. The left sides of this stepwise bit table are filled in with “1”s to form a sign extension bit region s1. A rectangular bit table is finally formed. Because the above sign extension bit region s1 is fixedly filled in with “1”s, in practice, it can first be operated to obtain a constant value. As shown in FIG. 2B, the total value is 10101011 (exemplified with an 8×8 multiplier). The blanks are filled in with “0”s. Here, each partial product term is assumed to be negative (−). This isn't necessarily correct. The present invention sets a plurality of complementary bits for this complement to determine whether the most significant bit (MSB) of each partial product term is 1 or 0 (i.e., whether each partial product term is negative or positive).

As shown in FIG. 2C, a first complementary bit c1 is provided before the MSB of the first partial product term a, a second complementary bit c2 is provided before the MSB of the second partial product term b, a third complementary bit c3 is provided before the MSB of the third partial product term c, and a fourth complementary bit c4 is provided before the MSB of the fourth partial product term d. The lowermost row is the total value s2 of sign extension bits obtained in advance. If the MSB of the above partial product term a, b, c, or d is 1 (i.e., the partial product term is negative), the sign extension bit region s1 is correctly set to 1. The corresponding complementary bit is thus set to 0 without affecting the correct value. If the MSB is 0 (i.e., the partial product term is positive), the sign extension bit region s1 is wrongly set to 1. The complementary bit is thus set to 1. In binary addition, a binary number with all bits being “1” added to by 1 sets all bits to 0 except the bit with the largest weight (i.e., the leftmost bit) without affecting the originally correct value. This is summarized below:
Case 1: if the MSB is 1, the complementary bit is 0;
Case 2: if the MSB is 0, the complementary bit is 1.

The complementary bits c1, c2, c3 and c4 and the MSB of each partial product term thus complement the total value s2 obtained by setting the sign extension bits to 1 in advance. Finally, each partial product term added to by the complementary bits and the total value (a constant) of sign extension bits is summed up to obtain the result of this multiplier. In a practical circuit, the complementary bits have no expense except inverters and some wires.

In order to reduce the added cost due to the excess total value s2 of sign extension bits (increase of critical paths), this total value s2 of sign extension bits is embedded in partial product terms in the present invention. Because the total value s2 of sign extension bits is a constant value, the critical paths can be reduced to the original number of layers through this embedding method matched with some excess complementary bits.

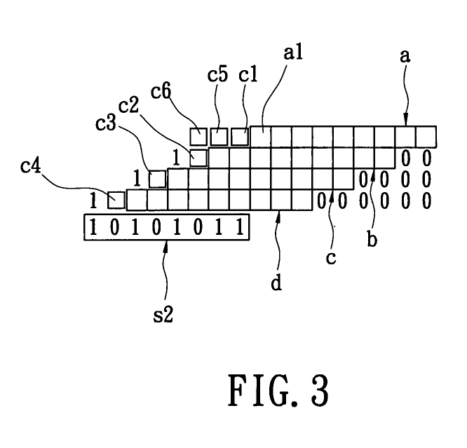

As shown in FIG. 3, the total value s2 of sign extension bits is embedded in sign extension bits of partial product terms. The first complementary bit c2 will be affected, but other complementary bits are unchanged. Therefore, a first correction bit c5 and a second correction bit c6 are added before the MSB a1 of the first partial product term a, hence forming a second stepwise bit table shown in FIG. 2. The first correction bit c5 and the second correction bit c6 are determined according to the MSB a1 (Bit 1) of the first partial product term a and the embedded total value s2 of sign extension bits. The correction bits c5 and c6 and the first complementary bit c1 are affected if the last three bits of the total value s2 of sign extension bits are 011. If the MSB a1 of the first product term a is 1, all the sign extension bits are correctly set to 1. Therefore, c5, c6 and c1 are set to 011 with reference to the last three bits 011 of the total value s2 of sign extension bits. If the MSB a1 of the first product term a is 0, the sign extension bits are wrongly set to 1. Therefore, c5, c6 and c1 are set to 100 for complement with reference to the last three bits 011 of the total value s2 of sign extension bits. This is summarized below:

Case 1: if the MSB is 1, c5, c6 and c1 are set to 011;

Case 2: if the MSB is 0, c5, c6 and c1 are set to 100.

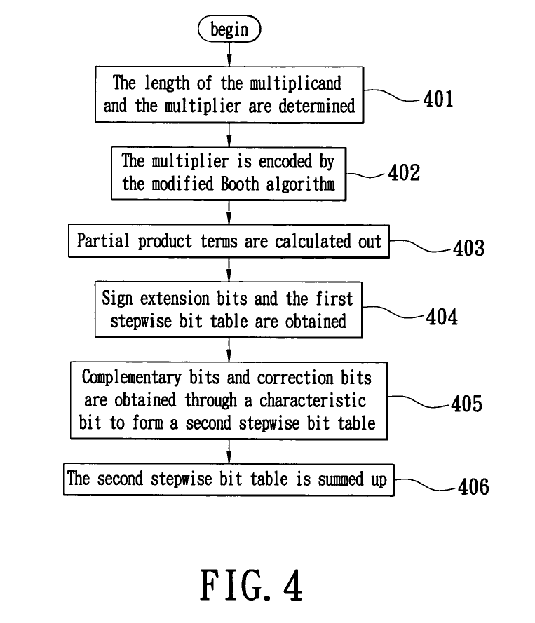

Reference is made to FIG. 4. First, the width of a multiplier is determined. That is, the numbers of bits of the multiplicand and multiplier are known, and the sign extension bit total value (a constant value obtained by summing up the sign extension bit region) is also determined (Step 401). Next, the multiplier is encoded by the modified Booth algorithm to obtain possible values (−M, +M, −2M, +2M) of partial product terms through 2's complement and shifting. The multiplier is taken apart with 3 bits as the unit. If there is one group having less than three bits after the multiplier is taken apart, “0” or “1” must be filled in without affecting the result (Step 402). The multiplicand is then multiplied by the above encoded multiplier to obtain partial product terms (Step 403). The partial product terms are arranged according to the rules of the modified Booth algorithm to obtain sign extension bits and a first stepwise bit table (Step 404). The complementary bits and the first and second correction bits are determined according to the MSB (Bit 1) of each partial product term to form a second stepwise bit table (Step 405). The plurality of layers of the second stepwise bit table formed in Step 405 is summed up to obtain the result of the 8-bit multiplier in this embodiment of the present invention (Step 406). The above multiplicand and multiplier can be interchanged.

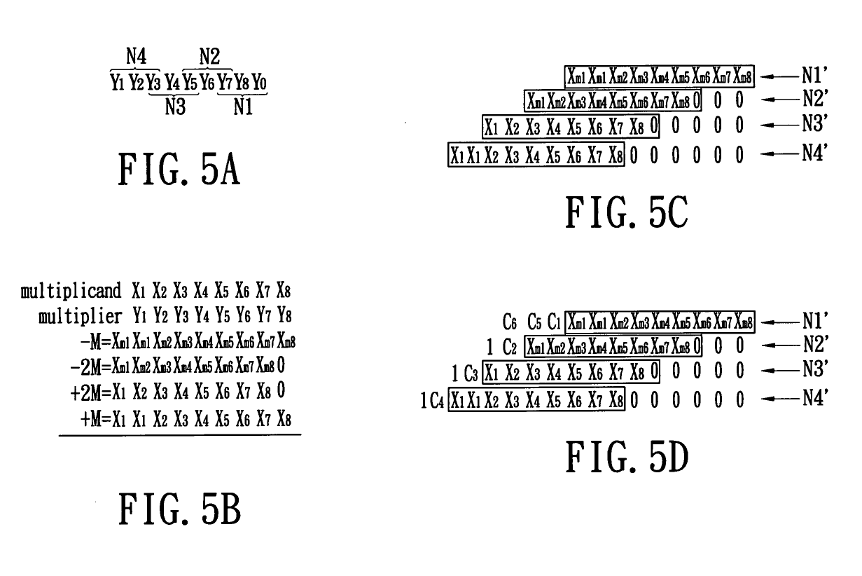

Reference is made to FIGS. 5A to 5D. This embodiment is exemplified with an 8-bit multiplicand and an 8-bit multiplier. The multiplicand M is represented by X₁X₂X₃X₄X₅X₆X₇X₈, while the multiplier N is represented by Y₁Y₂Y₃Y₄Y₅Y₆Y₇Y₈. The multiplier sign extension method of the present invention comprises the following steps:

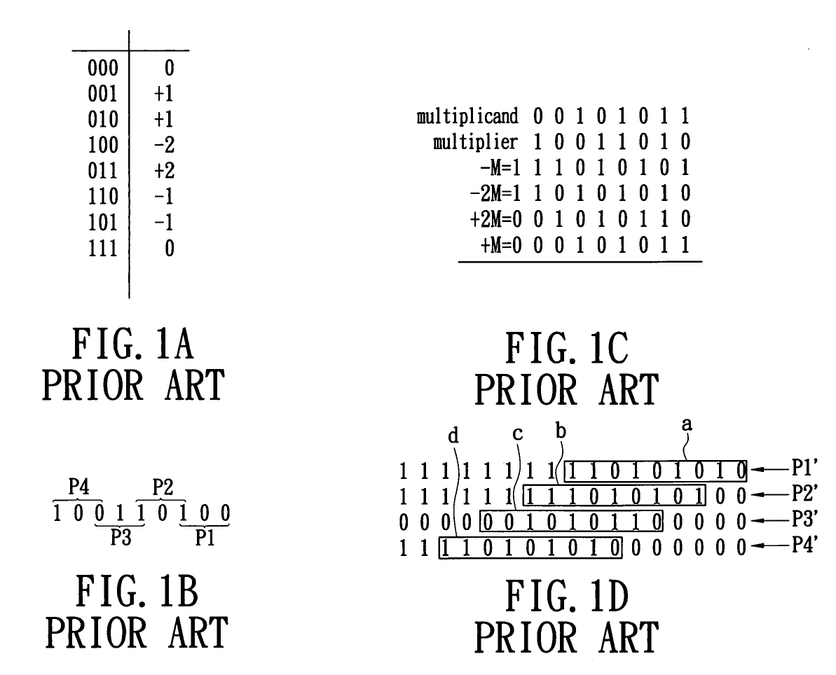

Step 1: From the table shown in FIG. 1A of the 3-bit modified Booth algorithm in the prior art, the value of each 3-bit group can be known: 000 means 0, 001 means +1, 010 means +1, 100 means −2, 011 means +2, 110 means −1, 101 means −1, and 111 means 0.

Step 2: The multiplier N (or the multiplicand M) is taken apart into a plurality of groups and encoded with 3 bits as the unit of group. The value of each group is obtained with reference to the table in Step 1. Bit 1 and Bit 3 of each group are Bit 3 or Bit 1 of an adjacent group. If there is one group having less than three bits after the multiplier is taken apart, “0” or “1” must be filled in behind the last group (or before the first group) without affecting the result. As shown in FIG. 5A, the first group N1 is Y₇Y₈Y₀, the second group N2 is Y₅Y₆Y₇, the third group N3 is Y₃Y₄Y₅, and the fourth group N4 is Y₁Y₂Y₃, where Y₀ is an initial reference bit, whose value is always 0. The value of each group is obtained with reference to the table in Step 1.

Step 3: The value of each group obtained in Step 2 is multiplied by the multiplicand M (or the multiplier N if the multiplicand M is encoded in Step 2) to obtain a plurality of partial product terms. The number of terms is determined by the number of groups in Step 2. From the bit table of the 3-bit modified Booth algorithm, the value of each group can be 0, −1, +1, −2 and +2. The partial product term thus can be −M, −2M, +2M and +M, where −M means 2's complement of the multiplicand M and is represented by Xₘ₁Xₘ₂Xₘ₃Xₘ₄Xₘ₅Xₘ₆Xₘ₇Xₘ₈. A more bit is generated for +M and −M by means of sign extension to be able to represent twice of the multiplicand. Therefore, +M is X₁X₂X₃X₄X₅X₆X₇X₈. −M is Xₘ₁Xₘ₂Xₘ₃Xₘ₄Xₘ₅Xₘ₆Xₘ₇Xₘ₈. +2M is +M left shifted by 1 bit with a “0” filled in the last bit, i.e., X₁X₂X₃X₄X₅X₆X₇X₈O shown in the figure. −2M is −M left shifted by 1 bit with a “0” filled in the last bit, i.e., Xₘ₁Xₘ₂Xₘ₃Xₘ₄Xₘ₅Xₘ₆Xₘ₇Xₘ₈O shown in the figure.

Step 4: The above partial product terms −M, −2M, +2M and +M are continually combined with the N1, N2, N3 and N4 obtained by encoding the multiplier. If the value of one group is −1, −M is substituted in. If the value of one group is −2, −2M is substituted in. If the value of one group is +1, +M is substituted in. If the value of one group is +2, +2M is substituted in. The stepwise bit table and sign extension bit table shown in FIG. 5C are partial product terms obtained by encoding the multiplicand M and the multiplier N. In this embodiment, the value of the first group N1 is −1, the value of the second group N2 is −2, the value of the third group N3 is +2, and the value of the fourth group N4 is +1. The first row N1′ shows the partial product term with the value of the first group N1 being −1, i.e., the value of −M (Xₘ₁Xₘ₂Xₘ₃Xₘ₄Xₘ₅Xₘ₆Xₘ₇Xₘ₈). The second row N2′ shows the partial product term with the value of the second group N2 being −2, i.e., the value of −2M (Xₘ₁Xₘ₂Xₘ₃Xₘ₄Xₘ₅Xₘ₆Xₘ₇Xₘ₈O) left shifted by two bits. The third row N3′ shows the partial product term with the value of the third group N3 being +2, i.e., the value of +2M (X₁X₂X₃X₄X₅X₆X₇X₈O) left shifted by four bits. The fourth row N4′ shows the partial product term with the value of the fourth group N4 being +1, i.e., the value of +M (X₁X₂X₃X₄X₅X₆X₇X₈) left shifted by six bits. The partial product terms in the rows N1′, N2′, N3′ and N4′ forms the first stepwise bit table shown in the figure. The left and right sides of this stepwise bit table composed of the partial product terms has blanks. Without affecting the result, the right blanks are filled in with “0”s, and the left blanks represent the sign extension bit region, which is a constant value filled in with “1”s, i.e., the sign extension bit total value shown in FIG. 2B.

Step 5: Because the above sign extension bit total value is the result obtained by setting all sign extension bits to 1, it is necessary to determine the values of the complementary bits c1, c2, c3 and c4 and the correction bits c5 and c6 by the MSB of the rows N1′, N2′, N3′ and N4′ of the partial product terms of the above first stepwise bit table. A second stepwise bit table is thus formed. With the exception of the first MSB (e.g., Xₘ₁ of the first row N1′), if the MSB of a row is 1 (i.e., the partial product term is negative), the corresponding complementary bit is set to 0. If the MSB of a row is 0 (i.e., the partial product term is positive), the corresponding complementary bit is set to 1. If the first MSB is 1, the first correction bit c5, the second correction bit c6 and the first complementary bit c1 are set to 011. If the first MSB is 1, the first correction bit c5, the second correction bit c6 and the first complementary bit c1 are set to 100.

Step 6: The rows of the second stepwise bit-table are summed up to obtain the answer.

The present invention reduces the width a multiplier, and further reduces sign extension bits. With the exception of the partial product term at the lowermost layer, bit operations at each layer can be saved.

To sum up, the present invention provides a plurality of complementary bits for encoding of sign extension in encoding operations used by a multiplier of a DSP. Other than some inverters and wires, no other cost is added. Moreover, the chip area can be reduced, and the performance can be enhanced.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A multiplier sign extension method with a plurality of complementary bits and a plurality of correction bits provided in the modified Booth algorithm for a multiplier, said method comprising the steps of:
determining a width of said multiplier to obtain a sign extension bit total value;
encoding a multiplier;
calculating out a plurality of layers of partial product terms by multiplying a multiplicand by said encoded multiplier to form a first stepwise bit table;
setting a plurality of complementary bits, a first correction bit and a second correction bit to form a second stepwise bit table; and
summing up the plurality of layers of said second stepwise bit table;
whereby said sign extension bit total value can be embedded in said plurality of layers of partial product terms without increasing critical paths.

2. The multiplier sign extension method as claimed in claim 1, wherein said sign extension bit total value is obtained by setting left sign extension bits of all said plurality of layers of partial product terms to 1 and then adding up said plurality of layers of partial product terms.

3. The multiplier sign extension method as claimed in claim 1, wherein values of said plurality of complementary bits are determined by a plurality of most significant bits of said plurality of layers of partial product terms.

4. The multiplier sign extension method as claimed in claim 3, wherein if said most significant bit is 1, a corresponding complementary bit is 0.

5. The multiplier sign extension method as claimed in claim 3, wherein if said most significant bit is 0, a corresponding complementary bit is 1.

6. The multiplier sign extension method as claimed in claim 1, wherein said first correction bit, said second correction bit and a first complementary bit are arranged before a most significant bit of a first layer of partial product terms of said first stepwise bit table.

7. The multiplier sign extension method as claimed in claim 6, wherein said first correction bit, said second correction bit and said first complementary bit are determined according to said first most significant bit.

8. The multiplier sign extension method as claimed in claim 6, wherein if the most significant bit of said first layer of partial product terms is 1, said first correction bit, said second correction bit and said first complementary bit are 0, 1, and 1, respectively.

9. The multiplier sign extension method as claimed in claim 6, wherein if the most significant bit of said first layer of partial product terms is 0, said first correction bit, said second correction bit and said first complementary bit are 1, 0, and 0, respectively.

10. A multiplier sign extension method, comprising the steps of:
determining a width of a multiplier to obtain a sign extension bit total value;
dividing the multiplier into a plurality of groups with 3 bits as the unit based on a 3-bit modified Booth algorithm to encode said multiplier;
calculating out a plurality of layers of partial product terms by operating a multiplicand with a value of each said group of said encoded multiplier to form a first stepwise bit table;
setting a plurality of complementary bits, a first correction bit and a second correction bit before a plurality of most significant bits of said plurality of layers of partial product terms to form a second stepwise bit table; and
summing up the plurality of layers of said second stepwise bit table;
whereby said sign extension bit total value can be embedded in said plurality of layers of partial product terms without increasing critical paths.

11. The multiplier sign extension method as claimed in claim 10, wherein said sign extension bit total value is obtained by setting left sign extension bits of all said plurality of layers of partial product terms to 1 and then adding up said plurality of layers of partial product terms.

12. The multiplier sign extension method as claimed in claim 10, wherein values of said plurality of complementary bits are determined according to said plurality of most significant bits.

13. The multiplier sign extension method as claimed in claim 12, wherein if said most significant bit is 1, a corresponding complementary bit is 0.

14. The multiplier sign extension method as claimed in claim 12, wherein if said most significant bit is 0, a corresponding complementary bit is 1.

15. The multiplier sign extension method as claimed in claim 10, wherein said first correction bit, said second correction bit and a first complementary bit are arranged before a most significant bit of a first layer of partial product terms of said first stepwise bit table.

16. The multiplier sign extension method as claimed in claim 15, wherein said first correction bit, said second correction bit and said first complementary bit are determined according to said first most significant bit.

17. The multiplier sign extension method as claimed in claim 15, wherein if the most significant bit of said first layer of partial product terms is 1, said first correction bit, said second correction bit and said first complementary bit are 0, 1, and 1, respectively.

18. The multiplier sign extension method as claimed in claim 15, wherein if the most significant bit of said first layer of partial product terms is 0, said first correction bit, said second correction bit and said first complementary bit are 1, 0, and 0, respectively.

19. A multiplier sign extension architecture with a plurality of complementary bits and a plurality of correction bits provided in the modified Booth algorithm for a multiplier, said architecture comprising:
a plurality of layers of partial product terms forming a first stepwise bit table; and
a plurality of complementary bits, a first correction bit and a second correction bit forming a second stepwise bit table.

20. The multiplier sign extension architecture as claimed in claim 19, wherein said first correction bit, said second correction bit and a first complementary bit are arranged before the most significant bit of a first layer of partial product terms of said first stepwise bit table.
